(19) United States
(12) Patent Application Publication
(10) Pub. No.: US 2026/0111159 A1
(43) Pub. Date: Apr. 23, 2026

(54) TERMINAL DEVICE, PRINTING SYSTEM, METHOD OF EDITING PRINT DATA, AND PROGRAM

(71) Applicant: Seiko Instruments Inc., Chiba-shi (JP)

(72) Inventor: Mari JOKEI, Chiba-shi (JP)

(21) Appl. No.: 19/363,377

(22) Filed: Oct. 20, 2025

(30) Foreign Application Priority Data
Oct. 22, 2024 (JP) 2024-186112

(51) Int. Cl. G06F 3/12

(52) U.S. Cl. CPC G06F 3/1242; G06F 3/1205

(57) ABSTRACT

A terminal device for editing print data to be output to a printing device, the terminal device includes: a printing region information acquisition module configured to acquire printing region information that specifies a printing region provided to a printing sheet for each type of printing sheet; a display control module configured to select a printing sheet of a first type and a printing sheet of each of one or a plurality of second types different from the first type based on the acquired printing region information, and display, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and an operation reception unit configured to receive an operation for changing dimensions of the printing region.

### RELATED APPLICATIONS

This application claims priority to Japanese Patent application No. JP2024-186112, filed on October 22, 2024, the entire content of which is incorporated herein by reference.

### BACKGROUND OF THE INVENTION

### 1. Field of the Invention

The present disclosure relates to a terminal device, a printing system, a method of editing print data, and a program.

### 2. Description of the Related Art

Hitherto, research and development have been conducted on technologies for printing an image of a label represented by label data onto a label liner.

In this regard, there is known a printing device capable of creating an image of a label having a format similar to that of an image of a label created in the past.

According to at least one embodiment of the present disclosure, it is possible to provide a terminal device, a printing system, a method of editing print data, and a program that enable a visual comparison between a frame image before a change in size and a frame image after the change in size, thereby being able to improve usability regarding the change in size of the frame image.

### SUMMARY OF THE INVENTION

According to one embodiment of the present invention, there is provided a terminal device for editing print data to be output to a printing device, the terminal device including: a printing region information acquisition module configured to acquire printing region information that specifies a printing region provided to a printing sheet for each type of printing sheet; a display control module configured to select a printing sheet of a first type and a printing sheet of each of one or a plurality of second types different from the first type based on the acquired printing region information, and display, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and an operation reception unit configured to receive an operation for changing dimensions of the printing region.

In the above-mentioned terminal device according to the one embodiment of the present invention, wherein the display control module is configured to display the second frame image in one of an inside or an outside of the first frame image in accordance with a direction of the received operation.

In the above-mentioned terminal device according to the one embodiment of the present invention, wherein the display control module is configured to display the second frame image by selecting, as the printing sheet of each of the one or the plurality of second types, the printing sheet having the printing region having dimensions corresponding to an amount of the received operation with the dimensions of the printing region provided to the printing sheet of the first type being used as a reference among a plurality of types of printing sheets specified in the printing region information.

In the above-mentioned, terminal device according to the one embodiment of the present invention, wherein the display control module is configured to display the second frame image by selecting, as the printing sheet of each of the one or the plurality of second types, the printing sheet having the printing region having dimensions that are closest to the dimensions of the printing region provided to the printing sheet of the first type among a plurality of types of printing sheets specified in the printing region information.

In the above-mentioned terminal device according to the one embodiment of the present invention, wherein the printing region information includes information indicating a type of printing sheet that is compatible with the printing device for each model of the printing device, wherein the terminal device further comprises a model information acquisition module configured to acquire model information indicating the model of the printing device, and wherein the display control module is configured to display the frame images by selecting the printing sheet of the first type and the printing sheet of each of the one or the plurality of second types from among the printing sheets that are compatible with the printing device of the model indicated by the model information among a plurality of types of printing sheets specified in the printing region information.

In the above-mentioned terminal device according to the one embodiment of the present invention, wherein the printing region information includes, for each type of printing sheet, information indicating at least one of intended use or a characteristic of the printing sheet corresponding to the each type of printing sheet, wherein the terminal device further comprises a sheet type information acquisition module configured to acquire sheet type information indicating the at least one of the intended use or the characteristic of the printing sheet, and wherein the display control module is configured to display the frame images by selecting the printing sheet of the first type and the printing sheet of each of the one or the plurality of second types from among the printing sheets that match the at least one of the intended use or the characteristic indicated by the sheet type information among a plurality of types of printing sheets specified in the printing region information.

In the above-mentioned terminal device according to the one embodiment of the present invention, wherein the display control module is configured to display, as the second frame image, an image representing a partial outline included in an outline of the printing region indicated by the printing region information.

In the above-mentioned terminal device according to the one embodiment of the present invention, wherein the display control module is configured to display the second frame images in display modes caused to differ between models of printing devices.

In the above-mentioned terminal device according to the one embodiment of the present invention, wherein the display control module is configured to display an object representing an image to be printed so as to be superimposed on the first frame image, and display the object subjected to one of enlargement or reduction in accordance with a ratio between the dimensions of the printing region indicated by the first frame image and the dimensions of the printing region indicated by the second frame image so as to be superimposed on the second frame image.

In the above-mentioned terminal device according to the one embodiment of the present invention, wherein the display control module is configured to display an object representing an image to be printed so as to be superimposed on the first frame image, and display the object having the same dimensions as dimensions of the object displayed on the first frame image so as to be superimposed on the second frame image regardless of a ratio between the dimensions of the printing region indicated by the first frame image and the dimensions of the printing region indicated by the second frame image.

In the above-mentioned terminal device according to the one embodiment of the present invention, wherein the display control module is configured to display each of the frame images having an original size, in which the dimensions of the printing region and dimensions of the each of the frame images on the display unit match each other.

According to one embodiment of the present invention, there is provided a printing system including: the above-mentioned terminal device; and a printing device to be connected, which is a printing device that is electrically connected to the terminal device in one of a wireless manner or a wired manner, wherein the terminal device includes a determination module configured to acquire model information indicating a model of the printing device to be connected from the printing device to be connected, to thereby determine the model of the printing device to be connected.

According to one embodiment of the present invention, there is provided a method of editing print data to be output to a printing device, the method including: acquiring printing region information that specifies a printing region provided to a printing sheet for each type of printing sheet; selecting a printing sheet of a first type and a printing sheet of each of one or a plurality of second types different from the first type based on the acquired printing region information, and displaying, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and receiving an operation for changing dimensions of the printing region.

According to one embodiment of the present invention, there is provided a program for causing a computer included in a terminal device for editing print data to be output to a printing device to execute: acquiring printing region information that specifies a printing region provided to a printing sheet for each type of printing sheet; selecting a printing sheet of a first type and a printing sheet of each of one or a plurality of second types different from the first type based on the acquired printing region information, and displaying, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and receiving an operation for changing dimensions of the printing region.

### BRIEF DESCRIPTION OF THE DRAWINGS

FIG. 1 is a diagram for illustrating one example of a configuration of a printing system 1 according to at least one embodiment of the present disclosure.

FIG. 2 is a diagram for illustrating one example of a hardware configuration of a terminal device 11.

FIG. 3 is a diagram for illustrating one example of a functional configuration of the terminal device 11.

FIG. 4 is a diagram for illustrating one example of a functional configuration of a printing device 12.

FIG. 5 is a diagram for illustrating one example of a first frame image F1 displayed on a data edit image P1.

FIG. 6 is a diagram for exemplifying objects arranged on the first frame image F1 illustrated in FIG. 5.

FIG. 7 is a diagram for illustrating one example of the data edit image P1 in which a second frame image F2 is displayed together with the first frame image F1.

FIG. 8 is a diagram for illustrating another example of the data edit image P1 in which the second frame image F2 is displayed together with the first frame image F1.

FIG. 9 is a diagram for illustrating one example of the data edit image P1 in which a part of the second frame image F2 is displayed together with the first frame image F1.

FIG. 10 is a diagram for illustrating another example of the data edit image P1 in which a part of the second frame image F2 is displayed together with the first frame image F1.

FIG. 11 is a diagram for illustrating still another example of the data edit image P1 in which a part of the second frame image F2 is displayed together with the first frame image F1.

FIG. 12 is a diagram for illustrating yet another example of the data edit image P1 in which a part of the second frame image F2 is displayed together with the first frame image F1.

FIG. 13 is a diagram for illustrating one example of the data edit image P1 in which a part of a second frame image F2-1 and a part of a second frame image F2-2 are displayed together with the first frame image F1.

FIG. 14 is a diagram for illustrating one example of the data edit image P1 in which a part of a second frame image F2-3 and a part of a second frame image F2-4 are displayed together with the first frame image F1.

FIG. 15 is a flowchart for illustrating one example of a processing flow in which the terminal device 11 displays a second frame image in accordance with a resizing operation.

FIG. 16 is a flowchart for illustrating the example of the processing flow in which the terminal device 11 displays the second frame image in accordance with the resizing operation.

FIG. 17 is a table for showing one example of sheet type information.

### DETAILED DESCRIPTION OF THE PREFERRED EMBODIMENTS

Now, referring to the drawings, at least one embodiment of the present disclosure is described.

First, an overview of a printing system according to the at least one embodiment is described.

The printing system according to the at least one embodiment includes a terminal device and a printing device. The terminal device edits print data to be output to the printing device. Further, the terminal device includes a printing region information acquisition module, a display control module, and an operation reception unit. The printing region information acquisition module acquires printing region information that specifies a printing region provided to a printing sheet for each type of printing sheet. The display control module selects a printing sheet of a first type and a printing sheet of each of one or a plurality of second types different from the first type based on the acquired printing region information, and displays, among frame images indicating printing regions, a first frame image indicating the printing region provided to the selected printing sheet of the first type and a second frame image indicating the printing region provided to the selected printing sheet of the second type on a display unit such that the first frame image and the second frame image appear in different display modes. The operation reception unit receives an operation for changing dimensions of the printing region. The printing device is electrically connected to the terminal device in a wireless or wired manner. With this configuration, the printing system enables a visual comparison between a frame image before a change in size and a frame image after the change in size, and can thereby improve usability regarding the change in size of the frame image.

A configuration of the printing system according to the at least one embodiment, a configuration of the terminal device provided to the printing system, and processing to be performed by the terminal device are each described in detail below.

### <Configuration of Printing System>

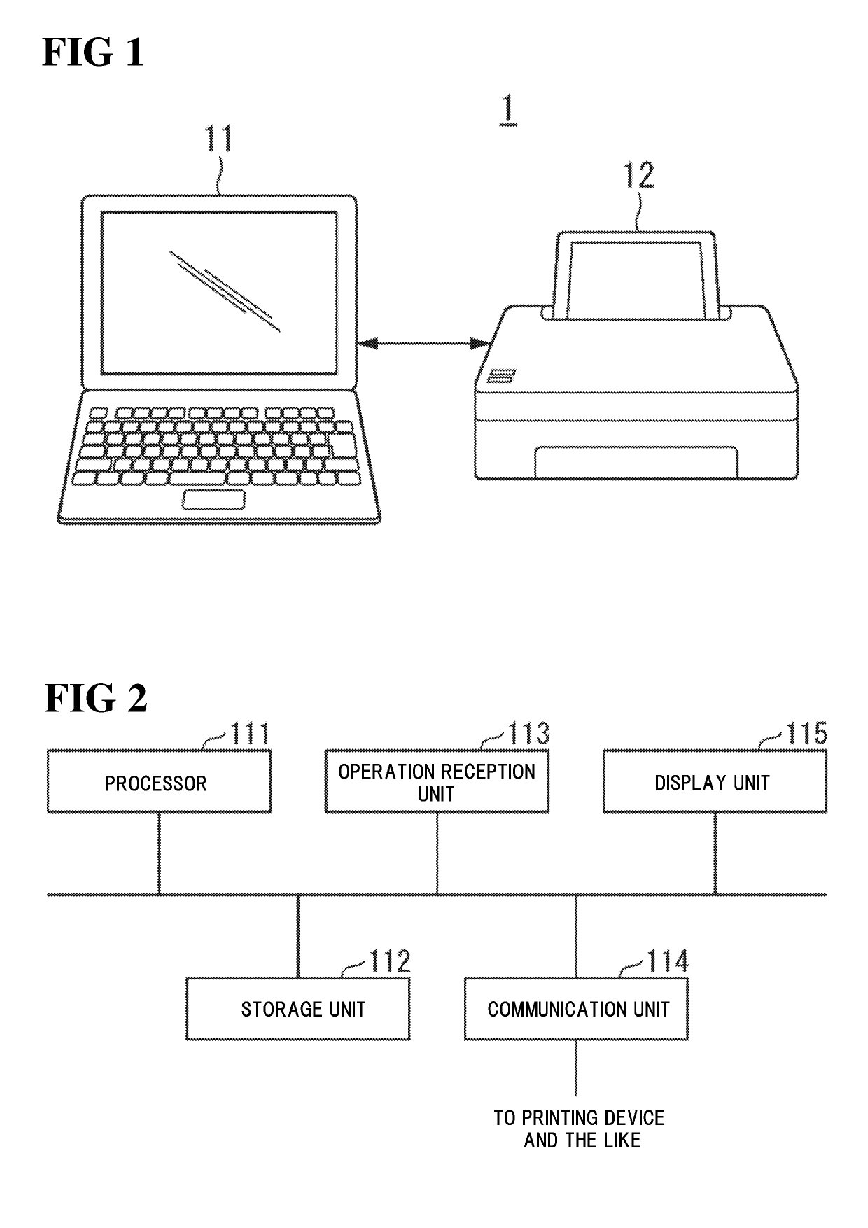

First, a configuration of a printing system 1 according to the at least one embodiment is described with reference to FIG. 1. FIG. 1 is a diagram for illustrating one example of the configuration of the printing system 1 according to the at least one embodiment. In the printing system 1, a terminal device 11 and a printing device 12 are connected to each other so as to enable communication therebetween in a wired or wireless manner. That is, the printing device 12 is an example of a printing device to be connected. In the at least one embodiment, the printing device 12 is a portable terminal including a thermal head. That is, in the at least one embodiment, the printing device 12 is a thermal printer. The printing device 12 prints an image represented by the print data onto various printing sheets. In the following, as an example, a case in which the printing device 12 prints an image of a label represented by label data onto a label liner is described. In this case, the label liner is a liner having one or more printing regions, each of which can be peeled off from the label liner, and can be affixed as a sticker. In the following, for the sake of convenience of description, the printing region provided to the label liner is referred to simply as "label." That is, the label liner is a liner having one or more labels. When the label liner has two or more labels, some or all of those two or more labels may be the same labels as one another, or may be different labels from one another. In the following, for the sake of simplicity of description, as an example, a case in which the label liner has only one label is described. Further, in the following, for the sake of convenience of description, the image of the label represented by the label data is referred to as "label image." That is, the printing device 12 in this example prints the label image onto the label on the label liner. The label liner is an example of the printing sheet. The printing sheet may also be referred to as "printing medium." Further, the label data is an example of the print data. Further, in the following, for the sake of convenience of description, a user of the printing system 1 is referred to simply as "user."

As the wired communication, for example, communication using Universal Serial Bus (USB) may be used. As the wireless communication, for example, communication using Wi-Fi (trademark) or communication using Bluetooth (trademark) may be used.

The terminal device 11 is a host terminal that controls the printing device 12, and is a computer, for example, a notebook computer, a laptop computer, a smartphone, or a tablet terminal.

The terminal device 11 edits the print data to be output to the printing device 12 in accordance with the received operation. For example, the terminal device 11 edits the label data, which is an example of the print data, in accordance with the received operation. At this time, the terminal device 11 displays a data edit image P1 for receiving a label data editing operation for editing the label data. The terminal device 11 receives the label data editing operation from the user through the data edit image P1 displayed on the terminal device 11. In the at least one embodiment, the label data editing operation is a general term for operations for performing generation, change, deletion, and the like of the label data. When the terminal device 11 displays the data edit image P1, the terminal device 11 receives liner type information indicating a type of label liner having a label having a size desired by the user. In other words, the terminal device 11 selects the type of label liner in accordance with the data editing operation. After having received the liner type information, the terminal device 11 acquires the printing region information. The printing region information is information that specifies the label provided to the label liner for each type of label liner. The terminal device 11 identifies the label provided to the label liner of the type indicated by the received liner type information, from among a plurality of labels specified in the acquired printing region information. The terminal device 11 generates a frame image indicating the identified label, and generates the data edit image P1 that includes the generated frame image. That is, the frame image generated by the terminal device 11 is displayed on the data edit image P1 generated in this manner. Then, the terminal device 11 displays the generated data edit image P1.

As described above, the frame image on the data edit image P1 displayed in this manner indicates the label provided to the label liner of the type represented by the liner type information received by the terminal device 11. More specifically, the frame image on the data edit image P1 indicates an outline of the label. Therefore, the user can arrange each type of object representing an image to be printed on the frame image on the data edit image P1, to thereby cause the terminal device 11 to generate label data representing a label image including the image represented by the each type of object. However, during editing of the label data, the user may wish to enlarge or reduce dimensions of the frame image on the data edit image P1. In this case, the dimensions of the frame image refer to dimensions of the outline of the label indicated by the frame image. In the following, for the sake of convenience of description, the dimensions of the frame image are referred to as "label image size." In a terminal device (for example, related-art terminal device) that is different from the terminal device 11 among terminal devices capable of displaying the data edit image P1, in a case of reducing or enlarging the label image size, the user has caused, by selecting a desired label image size from a list of a plurality of label image sizes that can be selected, the frame image having the selected label image size to be redisplayed on the data edit image P1. However, the list of label image sizes on such a terminal device has been a list of numerical values of vertical and horizontal dimensions of the label. With this list, it has been difficult to compare to the label image size displayed on such a terminal device, and it has sometimes been difficult for the user to guess how the frame image is to be changed in shape after the frame image is changed in size. This leads to a decrease in usability in label data creation, which is not desired.

In view of this, the terminal device 11 receives a resizing operation for changing the label image size. After having received the resizing operation, the terminal device 11 sets a frame image having the label image size corresponding to the resizing operation as the second frame image, and displays the second frame image together with the first frame image, which is the frame image on the data edit image P1 before the resizing operation is received. However, the terminal device 11 displays the second frame image in a display mode different from the display mode of the first frame image together with the first frame image. For example, the terminal device 11 displays the outline of the first frame image by a solid line, and displays the outline of the second frame image with a dotted line. With this configuration, the terminal device 11 enables a visual comparison between a frame image before a change in size and a frame image after the change in size, and can thereby improve usability regarding the change in size of the frame image. The type of the label liner having the label indicated by the first frame image is an example of the first type. Further, the type of the label liner having the label indicated by the second frame image is an example of the second type.

### <Hardware Configuration of Terminal Device>

Now, a hardware configuration of the terminal device 11 is described with reference to FIG. 2. FIG. 2 is a diagram for illustrating one example of the hardware configuration of the terminal device 11. For example, as illustrated in FIG. 2, the terminal device 11 includes a processor 111, a storage unit 112, an operation reception unit 113, a communication unit 114, and a display unit 115. In addition to those components, the terminal device 11 may have a configuration including another member or another device.

The processor 111 is, for example, a central processing unit (CPU). The processor 111 may be another processor such as a field programmable gate array (FPGA) in place of the CPU. The processor 111 executes various programs stored in the storage unit 112.

The storage unit 112 is a storage device, examples of which include a read only memory (ROM), a random access memory (RAM), an electrically erasable programmable read only memory (EEPROM), and a solid state drive (SSD). The storage unit 112 may be an external storage device connected through a digital input/output port such as a USB port in place of the storage device built into the terminal device 11. The storage unit 112 stores various types of information, various images, and various programs to be processed by the terminal device 11. That is, various types of information stored by the terminal device 11 are stored in the storage unit 112. The various programs include, for example, a printer driver of a printing device that can be connected to the terminal device 11 as the printing device 12.

The operation reception unit 113 is an input device, examples of which include a keyboard, a mouse, or a touch pad. In place of some or all of those input devices or in addition to all of those input devices, the operation reception unit 113 may have a configuration including another type of input device.

The communication unit 114 is a communication device including, for example, a digital input/output port such as a USB port, an Ethernet (trademark) port, and an antenna for wireless communication. The terminal device 11 communicates to/from another device such as the printing device 12 through the communication unit 114.

The display unit 115 is a display device, examples of which include a liquid crystal display. The display unit 115 may be configured integrally with at least a part of the operation reception unit 113 as a touch panel.

### <Functional Configuration of Terminal Device>

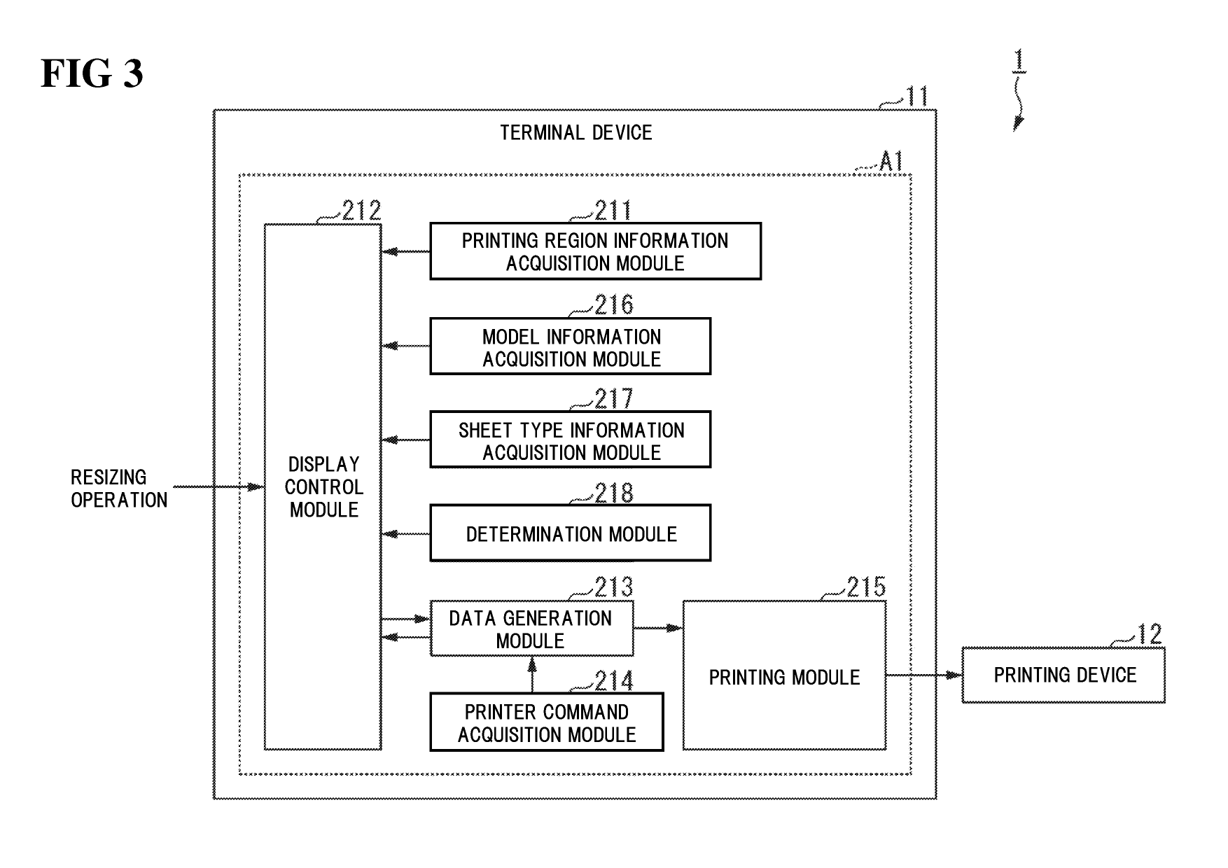

Now, a functional configuration of the terminal device 11 is described with reference to FIG. 3. FIG. 3 is a diagram for illustrating one example of the functional configuration of the terminal device 11. In FIG. 3, one example of a functional block A1 of the terminal device 11 is illustrated. The terminal device 11 includes, for example, a printing region information acquisition module 211, a display control module 212, a data generation module 213, a printer command acquisition module 214, a printing module 215, a model information acquisition module 216, a sheet type information acquisition module 217, and a determination module 218. Those functional modules included in the terminal device 11 are implemented by, for example, the processor 111 executing various programs stored in the storage unit 112. Further, some or all of the functional modules may be hardware functional modules such as a large scale integration (LSI) or an application specific integrated circuit (ASIC). The various programs may include, for example, the printer driver.

The printing region information acquisition module 211 acquires the printing region information stored in advance in the storage unit 112 from the storage unit 112.

The display control module 212 generates an image corresponding to an operation received by the terminal device 11, and displays the generated image on the display unit 115. For example, the display control module 212 generates the data edit image P1 in accordance with the received operation, and displays the generated data edit image P1 on the display unit 115. Further, for example, when the display control module 212 receives the resizing operation through the data edit image P1 displayed on the display unit 115, the display control module 212 identifies the label image size corresponding to the received resizing operation as a user-designated label image size. After having identified the user-designated label image size, the display control module 212 identifies, as a selectable label image size, each of one or more label image sizes close to the identified user-designated label image size. In this case, the display control module 212 acquires the printing region information from the printing region information acquisition module 211, and identifies a predetermined number of label image sizes in order of closeness to the user-designated label image size as one or more selectable label image sizes based on the acquired printing region information. The predetermined number may be any integer number equal to or greater than 1. The display control module 212 generates a second frame image having the selectable label image size for each of the identified one or more selectable label image sizes. Then, the display control module 212 displays the second frame image generated for each of the one or more selectable label image sizes together with the first frame image on the data edit image P1. At this time, the display control module 212 displays the one or more second frame images on the data edit image P1 in a display mode different from the display mode of the first frame image displayed on the data edit image P1. In addition, at this time, the display control module 212 displays the one or more second frame images on the data edit image P1 such that the display modes of the one or more second frame images are different from one another. Details of processing in which the display control module 212 displays the second frame image are described later. In addition, for example, the display control module 212 arranges, in accordance with an operation received through the data edit image P1, the objects designated by this operation on the first frame image.

The data generation module 213 generates label data based on one or more objects arranged on the first frame image on the data edit image P1 and a printer command acquired by the printer command acquisition module 214. A method of generating label data based on the one or more objects and the printer command may be a known method, or may be a method to be developed in the future. After having generated the label data, the data generation module 213 outputs the generated label data to the printing module 215. The printer command is a command for causing the printing device 12 to print the label image on the label provided to the label liner.

In the at least one embodiment, each piece of label data is binary data, and includes data on one or more objects as described above. The object may be referred to as, for example, "constituent element."

Each piece of label data includes information specifying a position and a size of each of the objects included in the label data.

Each piece of label data may also include information specifying the type of each of the objects included in the label data.

In the at least one embodiment, each piece of label data is formed in a predefined format, and based on each piece of label data, information on each object included in the label data can be extracted.

Examples of the type of each object may include a character, an image, a one-dimensional code, and a two-dimensional code.

The position of each object may be expressed through use of, for example, coordinates, or may be expressed through use of, a reference such as a top, a bottom, a left, and a right of a label. When the position is expressed through use of the reference such as the top, the bottom, the left, or the right of the label, for example, a mode in which an object is arranged at the top, the bottom, the left, or the right of the label or a mode in which an object is arranged to be separated from the top, the bottom, the left, or the right of the label by a predetermined distance may be used.

The size of each object may be expressed through use of, for example, a numerical value, or may be expressed through use of a range occupied by the object.

The printer command acquisition module 214 receives the printer command through the operation reception unit 113, and outputs the received printer command to the data generation module 213.

The printing module 215 generates print data for causing the printing device 12 to execute printing of the label image represented by the label data acquired from the data generation module 213 onto the label on the label liner, and outputs the generated print data to the printing device 12.

The model information acquisition module 216 acquires model information indicating a model of the printing device connected to the terminal device 11 as the printing device 12.

The sheet type information acquisition module 217 acquires sheet type information. The sheet type information is information indicating at least one of intended use or a characteristic of the printing sheet designated by the user. That is, in this example, the sheet type information is information indicating at least one of intended use or a characteristic of the label liner designated by the user.

The determination module 218 acquires the model information indicating the model of the printing device connected to the terminal device 11 as the printing device 12 from the printing device, to thereby determine the model of the printing device. That is, the determination module 218 determines the model of the printing device 12.

### <Functional Configuration of Printing Device>

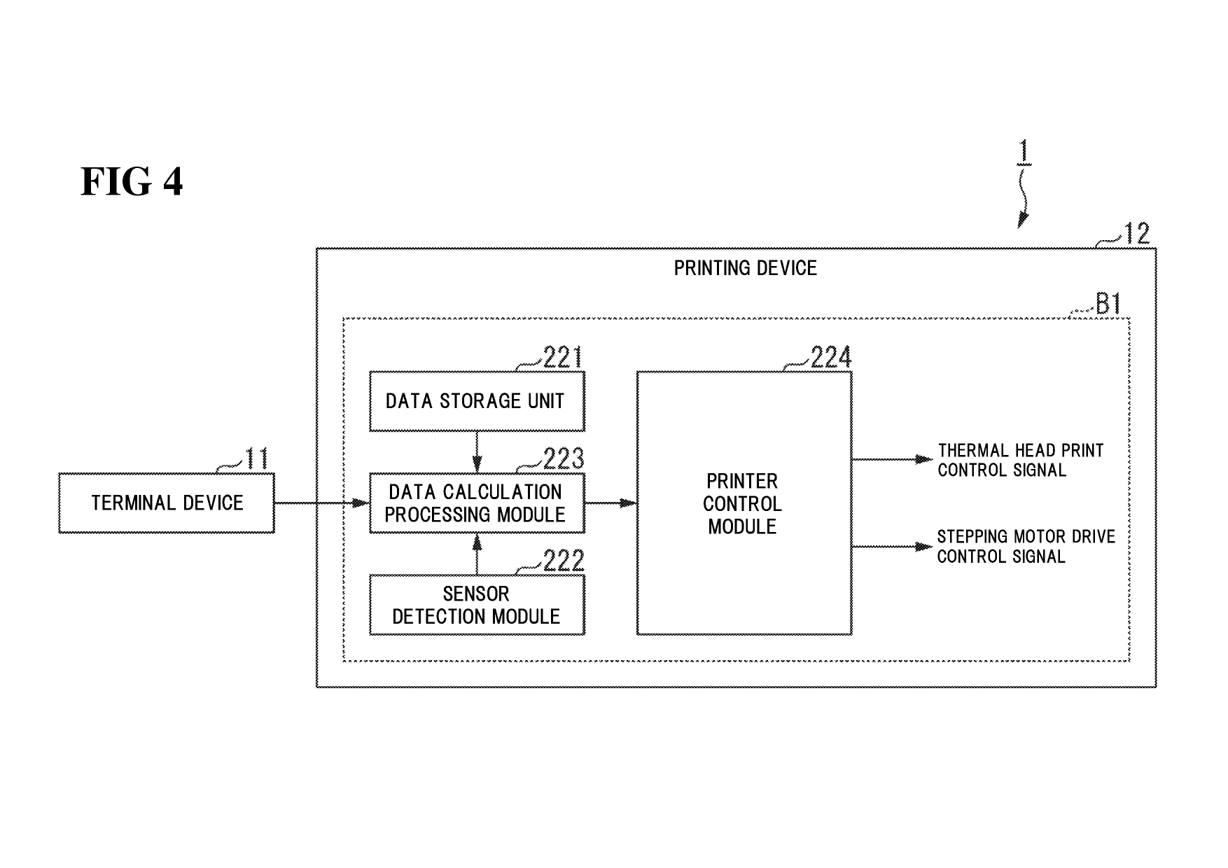

Now, a functional configuration of the printing device 12 is described with reference to FIG. 4. FIG. 4 is a diagram for illustrating one example of the functional configuration of the printing device 12. In FIG. 4, one example of a functional block B1 of the printing device 12 is illustrated. The printing device 12 includes, for example, a data storage unit 221, a sensor detection module 222, a data calculation processing module 223, and a printer control module 224.

In the at least one embodiment, the printing device 12 includes a processor such as a CPU and a memory such as a ROM and a RAM.

In the printing device 12, the processor executes a predetermined program, to thereby execute processing of the sensor detection module 222, the data calculation processing module 223, and the printer control module 224. The program may be stored in the memory.

In the printing device 12, the data storage unit 221 is formed by the memory.

The data storage unit 221 stores predetermined data.

The data storage unit 221 outputs the data to the data calculation processing module 223.

In the at least one embodiment, the data is, for example, data such as a parameter to be used in printing, but it is not always required to use such data.

The sensor detection module 222 acquires a detection value obtained by a sensor included in the printing device 12, and outputs the acquired detection value to the data calculation processing module 223.

Examples of the sensor include a sensor that detects presence or absence of a printing sheet such as a label liner.

The data calculation processing module 223 acquires the print data from the terminal device 11.

The data calculation processing module 223 performs predetermined calculation processing based on the print data acquired from the terminal device 11, the data stored in the data storage unit 221, and the detection value detected by the sensor detection module 222 to generate a printing control signal for printing the image represented by the print data onto the printing sheet.

The data calculation processing module 223 outputs the generated printing control signal to the printer control module 224.

The printer control module 224 controls a thermal head (not shown) and a stepping motor (not shown) based on the printing control signal input from the data calculation processing module 223.

In the at least one embodiment, the printer control module 224 outputs a thermal head print control signal to the thermal head, and the printer control module 224 outputs a stepping motor drive control signal to the stepping motor.

### <Specific Example of Second Frame Image displayed Together with First Frame Image>

Now, referring to the drawings, a specific example of the second frame image displayed together with the first frame image on the terminal device 11 is described.

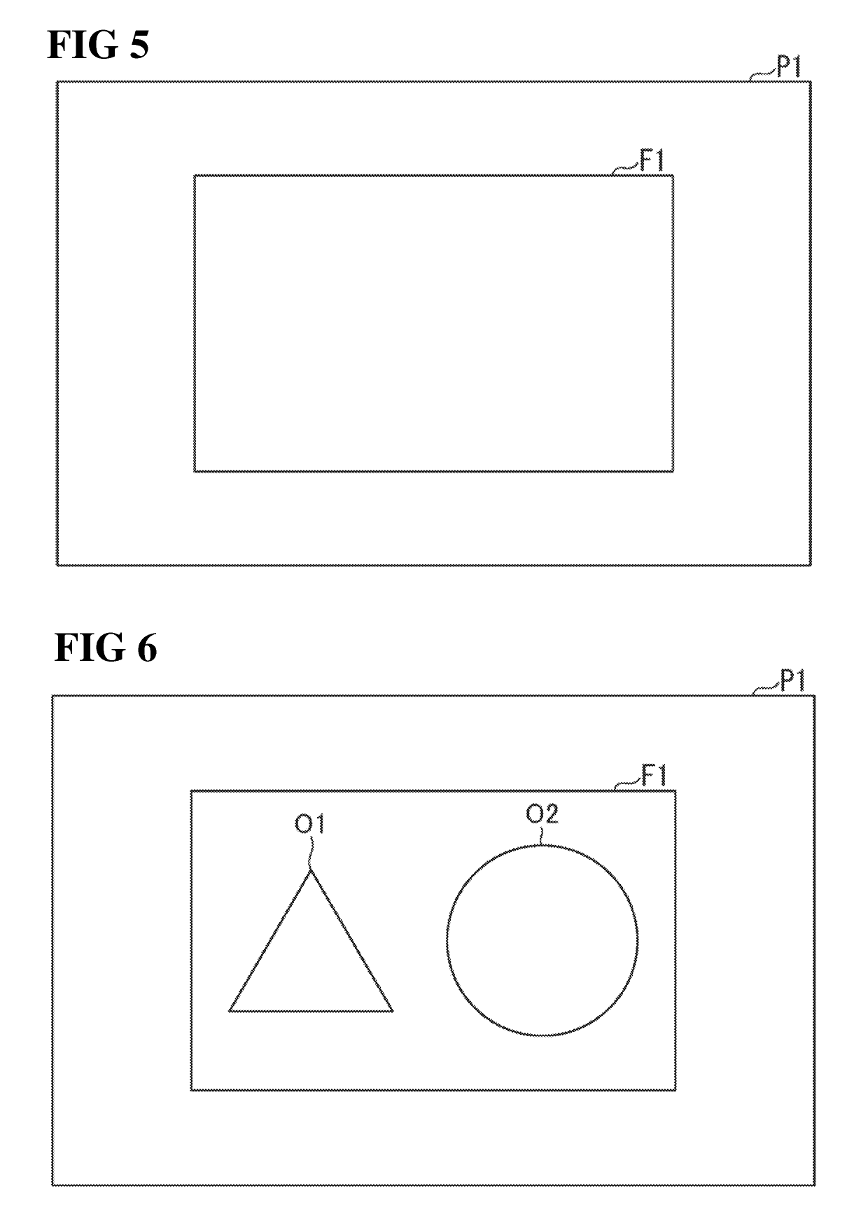

FIG. 5 is a diagram for illustrating one example of the first frame image displayed on the data edit image P1. The data edit image P1 illustrated in FIG. 5 is an illustration of one example of a data edit image. As illustrated in FIG. 5, a first frame image F1 is displayed on the data edit image P1. However, in FIG. 5, in order to simplify the drawing, images (for example, graphical user interfaces (GUIs) such as buttons for receiving various operations) other than the first frame image F1 among images displayed on the data edit image P1 are omitted. In the example illustrated in FIG. 5, nothing is arranged on the first frame image F1. This is because the user has not arranged any object on the first frame image F1. The terminal device 11 generates label data based on one or more objects arranged on the first frame image F1 and the label indicated by the first frame image F1. In the at least one embodiment, the wording "on the first frame image F1" refers to being included in a region surrounded by the outline of the first frame image F1.

FIG. 6 is a diagram for exemplifying objects arranged on the first frame image F1 illustrated in FIG. 5. In the example illustrated in FIG. 6, two objects, namely, an object O1 representing a triangle and an object O2 representing a circle, are arranged on the first frame image F1. In this case, the terminal device 11 generates label data for printing images respectively represented by the two objects arranged on the first frame image F1 onto the label indicated by the first frame image F1 as the label image.

In this case, the user can perform the resizing operation on the terminal device 11 through the data edit image P1, to thereby cause the terminal device 11 to display a second frame image F2, which is a frame image that is displayed together with the first frame image F1 after the label image size is changed, on the data edit image P1. For example, when the resizing operation is a swipe on the data edit image P1 on the touch panel, the terminal device 11 displays the second frame image F2 inside or outside the first frame image F1 in accordance with a direction of the received resizing operation.

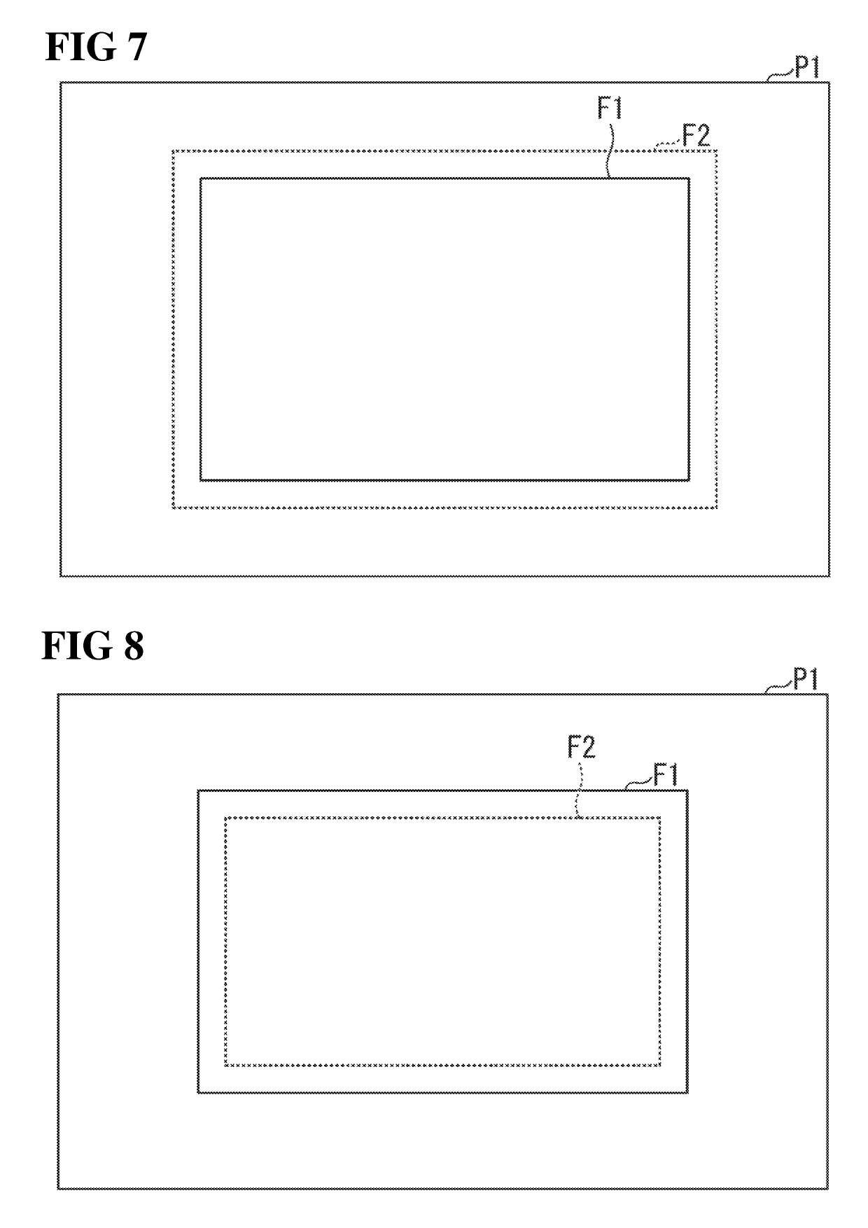

More specifically, when a swipe is performed in a direction from the inside of the first frame image F1 toward the outside of the first frame image F1, the terminal device 11 displays the second frame image F2 outside the first frame image F1. At this time, the terminal device 11 identifies, as the user-designated label image size, a label image size corresponding to a length of the swipe (an example of an amount of the operation for changing the dimensions of the printing region) with the label image size of the first frame image F1 being used as a reference. A method of identifying the user-designated label image size corresponding to the length of the swipe with the label image size of the first frame image F1 being used as a reference may be a known method, or may be a method to be developed in the future. The terminal device 11 identifies the above-mentioned one or more selectable label image sizes based on the identified user-designated label image size and the printing region information stored in advance. In this case, for the sake of simplicity of description, a case in which the terminal device 11 identifies only one selectable label image size based on the user-designated label image size and the printing region information is described. After having identified the selectable label image size, the terminal device 11 displays the second frame image F2 having the identified selectable label image size together with the first frame image F1 on the data edit image P1 as illustrated in FIG. 7. FIG. 7 is a diagram for illustrating one example of the data edit image P1 in which the second frame image F2 is displayed together with the first frame image F1. In the example illustrated in FIG. 7, the second frame image F2 is an image in which only the outline of the second frame image F2 is indicated by the dotted line unlike the first frame image F1. As illustrated in FIG. 7, the second frame image F2 is displayed outside the first frame image F1. This is because the user has swiped from the inside of the first frame image F1 toward the outside of the first frame image F1 in order to display the second frame image F2 having a label image size larger than the label image size of the first frame image F1. In this manner, when the resizing operation is received, the second frame image F2 in a display mode different from the display mode of the first frame image F1 is displayed together with the first frame image F1 on the data edit image P1. Therefore, the terminal device 11 enables a visual comparison between a frame image before a change in size and a frame image after the change in size, and can thereby improve usability regarding the change in size of the frame image.

Meanwhile, when a swipe is performed in a direction from the outside of the first frame image F1 toward the inside of the first frame image F1, the terminal device 11 displays the second frame image F2 inside the first frame image F1. At this time, the terminal device 11 identifies, as the user-designated label image size, a label image size corresponding to the length of the swipe with the label image size of the first frame image F1 being used as a reference. Then, in this example, the terminal device 11 identifies one selectable label image size based on the identified user-designated label image size and the printing region information stored in advance. After having identified the selectable label image size, the terminal device 11 displays the second frame image F2 having the identified selectable label image size together with the first frame image F1 on the data edit image P1 as illustrated in FIG. 8. FIG. 8 is a diagram for illustrating another example of the data edit image P1 in which the second frame image F2 is displayed together with the first frame image F1. In the example illustrated in FIG. 8, the second frame image F2 is an image in which only the outline of the second frame image F2 is indicated by the dotted line unlike the first frame image F1. As illustrated in FIG. 8, the second frame image F2 is displayed inside the first frame image F1. This is because the user has swiped from the outside of the first frame image F1 toward the inside of the first frame image F1 in order to display the second frame image F2 having a label image size smaller than the label image size of the first frame image F1. In this manner, when the resizing operation is received, the second frame image F2 in a display mode different from the display mode of the first frame image F1 is displayed together with the first frame image F1 on the data edit image P1. Therefore, the terminal device 11 enables a visual comparison between a frame image before a change in size and a frame image after the change in size, and can thereby improve usability regarding the change in size of the frame image.

The terminal device 11 can display, on the display unit 115, the first frame image F1 having an original size, in which actual dimensions of the label indicated by the first frame image F1 and the label image size of the first frame image F1 on the display unit 115 match each other, in accordance with an operation received through the data edit image P1. In this case, the terminal device 11 displays, on the display unit 115, the second frame image F2 having an original size, in which actual dimensions of the label indicated by the second frame image F2 and the label image size of the second frame image F2 on the display unit 115 match each other. The terminal device 11 can also display, on the display unit 115, the first frame image F1 and the second frame image F2 having sizes different from the original sizes in accordance with an operation received through the data edit image P1. This operation is an operation different from the resizing operation.

Further, the terminal device 11 may be configured to display, when displaying the second frame image F2 on the data edit image P1, a part of the second frame image F2 together with the first frame image F1 on the data edit image P1.

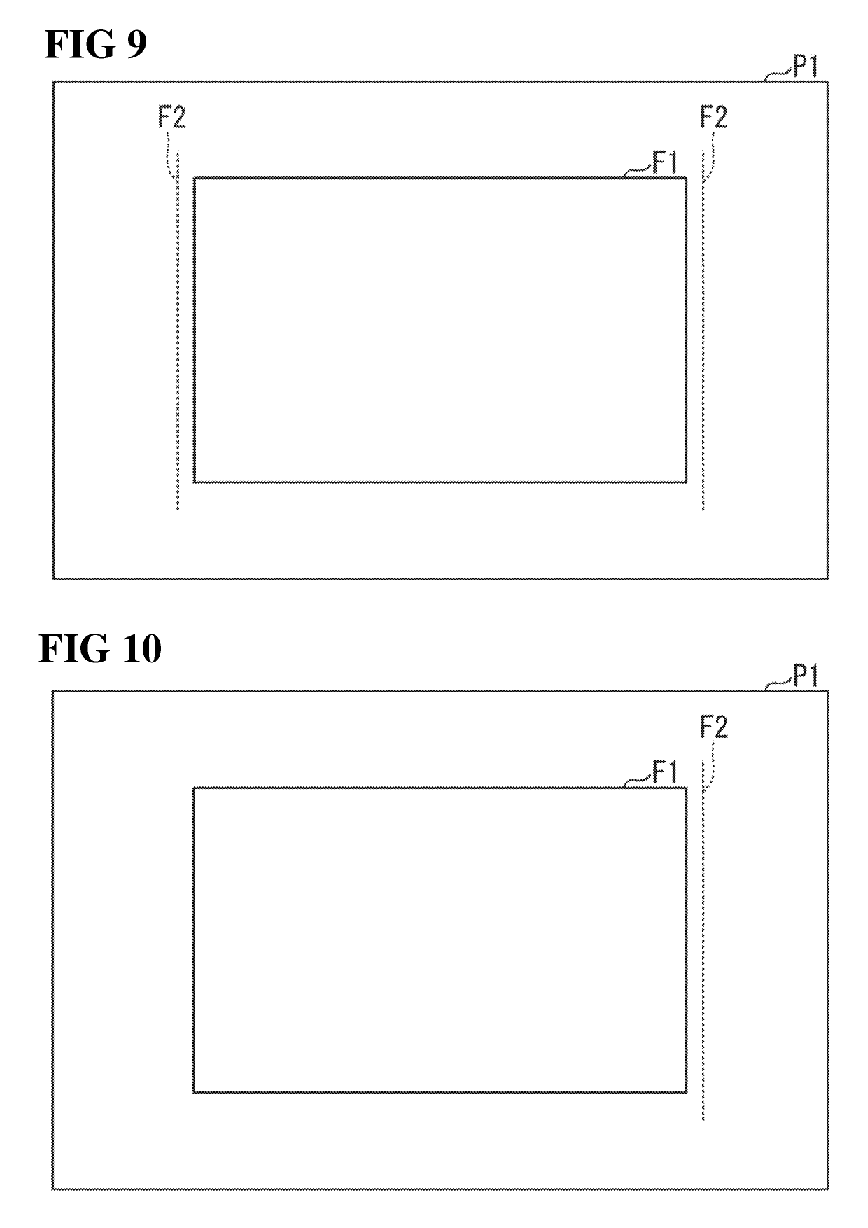

FIG. 9 is a diagram for illustrating one example of the data edit image P1 in which a part of the second frame image F2 is displayed together with the first frame image F1. In the example illustrated in FIG. 7, the shape of the second frame image F2 is rectangular. This is because the shape of the first frame image F1 is rectangular. In contrast, in the example illustrated in FIG. 9, only two opposing short sides among four sides provided to the outline of the rectangular second frame image F2 are displayed on the data edit image P1 as the part of the second frame image F2 together with the first frame image F1. In this case as well, the terminal device 11 enables a visual comparison between a frame image before a change in size and a frame image after the change in size. As a result, the terminal device 11 can improve usability regarding the change in size of the frame image. When only the two short sides are to be displayed as the part of the second frame image F2, the resizing operation may be an operation for selecting any one of two opposing short sides among four sides provided to the rectangular first frame image F1 by a touch operation, dragging with a mouse, or the like, and moving the selected short side.

Meanwhile, FIG. 10 is a diagram for illustrating another example of the data edit image P1 in which a part of the second frame image F2 is displayed together with the first frame image F1. In the example illustrated in FIG. 10, only one short side of the two opposing short sides among the four sides provided to the outline of the rectangular second frame image F2 is displayed on the data edit image P1 as the part of the second frame image F2 together with the first frame image F1. In this case as well, the terminal device 11 enables a visual comparison between a frame image before a change in size and a frame image after the change in size. As a result, the terminal device 11 can improve usability regarding the change in size of the frame image. When only the one short side is to be displayed as the part of the second frame image F2, the resizing operation may be an operation for selecting a short side among the four sides provided to the rectangular first frame image F1 that is closest to the one short side by a touch operation, dragging with a mouse, or the like, and moving the selected short side.

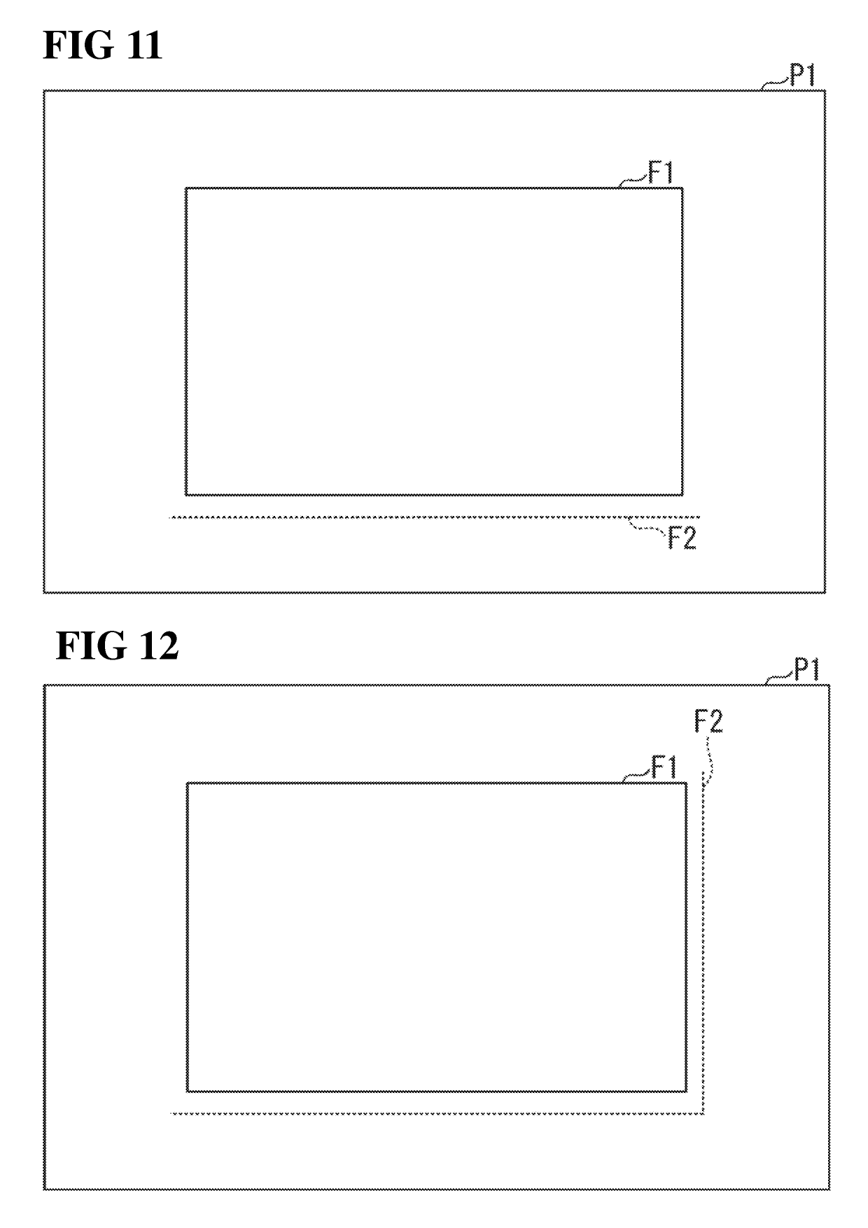

Further, FIG. 11 is a diagram for illustrating still another example of the data edit image P1 in which a part of the second frame image F2 is displayed together with the first frame image F1. In the example illustrated in FIG. 11, only one long side among the four sides provided to the outline of the rectangular second frame image F2 is displayed on the data edit image P1 as the part of the second frame image F2 together with the first frame image F1. In this case as well, the terminal device 11 enables a visual comparison between a frame image before a change in size and a frame image after the change in size. As a result, the terminal device 11 can improve usability regarding the change in size of the frame image. When only the one long side is to be displayed as the part of the second frame image F2, the resizing operation may be an operation for selecting a long side among the four sides provided to the rectangular first frame image F1 that is closest to the one long side by a touch operation, dragging with a mouse, or the like, and moving the selected long side.

Further, FIG. 12 is a diagram for illustrating yet another example of the data edit image P1 in which a part of the second frame image F2 is displayed together with the first frame image F1. In the example illustrated in FIG. 12, a combination of one long side and one short side adjacent to the one long side among the four sides provided to the outline of the rectangular second frame image F2 is displayed on the data edit image P1 as the part of the second frame image F2 together with the first frame image F1. In this case as well, the terminal device 11 enables a visual comparison between a frame image before a change in size and a frame image after the change in size. As a result, the terminal device 11 can improve usability regarding the change in size of the frame image. When the combination is to be displayed as the part of the second frame image F2, the resizing operation may be an operation for selecting a corner among four corners provided to the rectangular first frame image F1 that is closest to a corner provided to the combination by a touch operation, dragging with a mouse, or the like, and moving the selected corner.

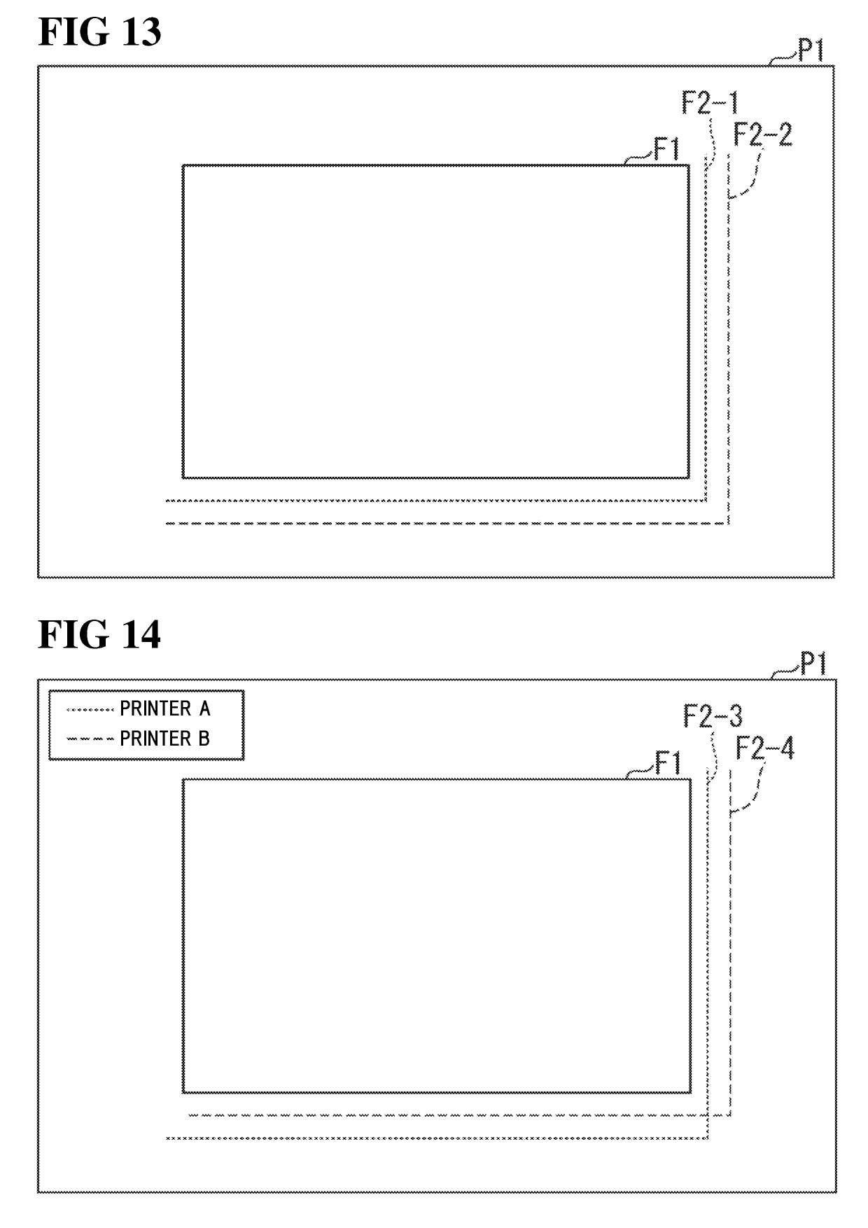

Further, the terminal device 11 may be configured to display a plurality of second frame images F2 on the data edit image P1 together with the first frame image F1. For example, the terminal device 11 identifies, as the selectable label image sizes, two label image sizes, namely, a label image size that is closest to the identified user-designated label image size and a label image size that is second closest to the identified user-designated label image size. Then, the terminal device 11 generates a second frame image having one of the two selectable label image sizes as a second frame image F2-1, and a second frame image having the other one of the two selectable label image sizes as a second frame image F2-2. The terminal device 11 displays each of a part of the generated second frame image F2-1 and a part of the generated second frame image F2-2 on the data edit image P1 together with the first frame image F1 as illustrated in FIG. 13. FIG. 13 is a diagram for illustrating one example of the data edit image P1 in which the part of the second frame image F2-1 and the part of the second frame image F2-2 are displayed together with the first frame image F1. When the terminal device 11 displays the part of the second frame image F2-1 and the part of the second frame image F2-2 on the data edit image P1, the terminal device 11 causes the display modes of the first frame image F1, the second frame image F2-1, and the second frame image F2-2 to differ from one another. With this configuration, the user can easily distinguish each of the first frame image F1, the second frame image F2-1, and the second frame image F2-2. As illustrated in FIG. 13, when a plurality of second frame images are displayed on the data edit image P1, the user can visually compare the frame images to each other, with the result that the user can more reliably select the second frame image indicating a desired frame. Each of the second frame image F2-1 and the second frame image F2-2 is an example of an image representing a partial outline included in an outline of the printing region indicated by the printing region information.

Further, for example, the terminal device 11 may be configured to identify, when a model desired to be used for the printing device 12 by the user is designated from among models of printing devices supported by a printer driver installed in the terminal device 11, one or more types of label liners that are compatible with the printing device of the designated model, and identify two label image sizes, namely, the label image size that is closest to the user-designated label image size and the label image size that is second closest to the user-designated label image size, as the selectable label image sizes from among label image sizes of labels provided to respective label liners of the identified one or more types.

Further, for example, the terminal device 11 may be configured to identify, when the model desired to be used for the printing device 12 by the user is not designated from among the models of printing devices supported by the printer driver installed in the terminal device 11, two label image sizes, namely, the label image size that is closest to the user-designated label image size and the label image size that is second closest to the user-designated label image size, as the selectable label image sizes from among label image sizes of labels provided to respective label liners of all types (or one or more predetermined types). For example, a case in which the terminal device 11 has identified, as such selectable label image sizes, the label image size of the label provided to the label liner that is compatible with a printer A and the label image size of the label provided to the label liner that is compatible with a printer B is assumed. In this case, for example, the terminal device 11 generates a second frame image having the selectable label image size corresponding to the printer A as a second frame image F2-3, and a second frame image having the selectable label image size corresponding to the printer B as a second frame image F2-4. The terminal device 11 displays each of a part of the generated second frame image F2-3 and a part of the generated second frame image F2-4 on the data edit image P1 together with the first frame image F1 as illustrated in FIG. 14. FIG. 14 is a diagram for illustrating one example of the data edit image P1 in which the part of the second frame image F2-3 and the part of the second frame image F2-4 are displayed together with the first frame image F1. When the terminal device 11 displays the part of the second frame image F2-3 and the part of the second frame image F2-4 on the data edit image P1, the terminal device 11 causes the display modes of the first frame image F1, the second frame image F2-3, and the second frame image F2-4 to differ from one another. With this configuration, the user can easily distinguish each of the first frame image F1, the second frame image F2-3, and the second frame image F2-4. In addition, the terminal device 11 displays information indicating the model of the printing device corresponding to the second frame image F2-3 on the data edit image P1 in association with the second frame image F2-3. In the example illustrated in FIG. 14, the information is the character string "PRINTER A" accompanied by a line type indicating the outline of the second frame image F2-3. In addition, the terminal device 11 displays information indicating the model of the printing device corresponding to the second frame image F2-4 on the data edit image P1 in association with the second frame image F2-4. In the example illustrated in FIG. 14, the information is the character string "PRINTER B" accompanied by a line type indicating the outline of the second frame image F2-4. As illustrated in FIG. 14, when second frame images corresponding respectively to a plurality of printing devices are displayed on the data edit image P1, the user can visually compare the frame images for the respective models of printing devices to each other, with the result that the user can more reliably select the second frame image indicating a desired frame. Each of the second frame image F2-3 and the second frame image F2-4 is an example of an image representing a partial outline included in an outline of the printing region indicated by the printing region information.

In the following, for the sake of convenience of description, the model desired to be used for the printing device 12 by the user among the models of printing devices supported by the printer driver installed in the terminal device 11 is referred to as "user-designated model."

### <Processing for displaying Second Frame Image by Terminal Device in Accordance with Resizing Operation>

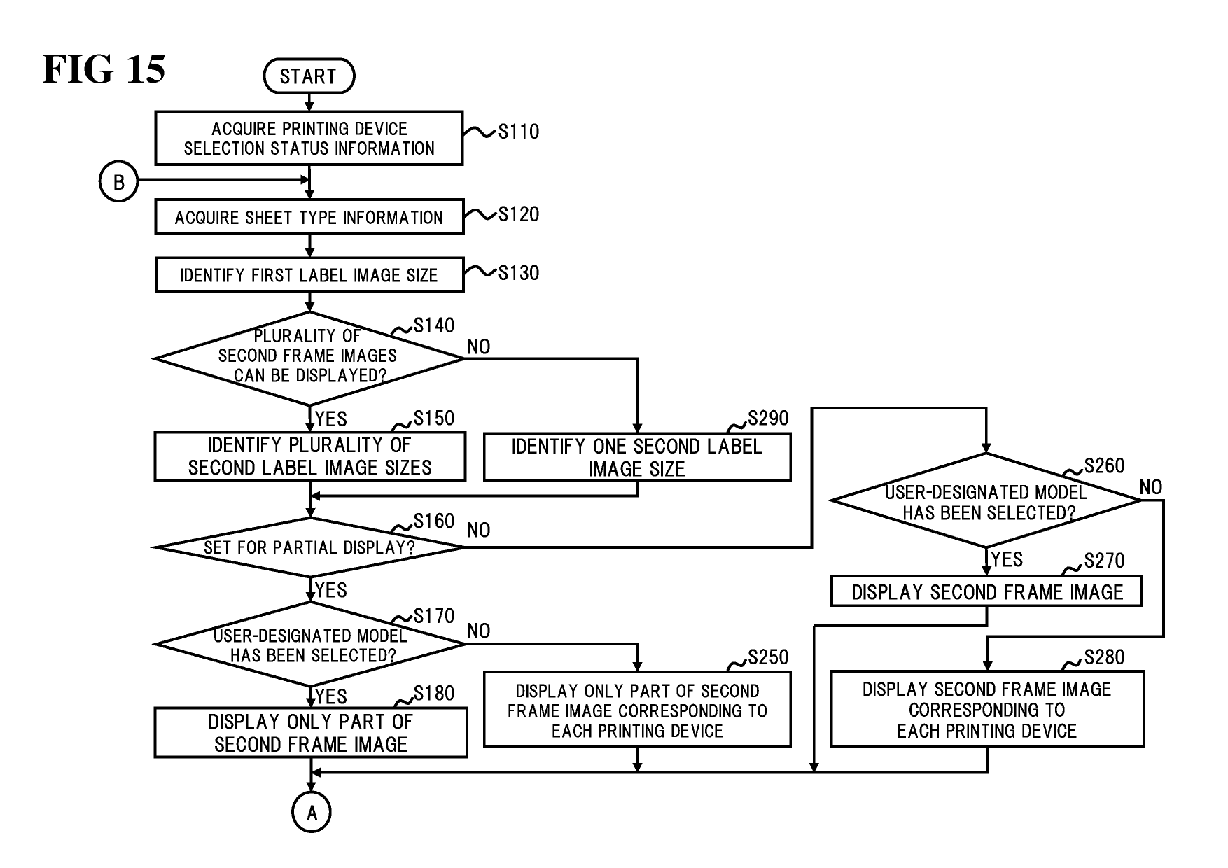

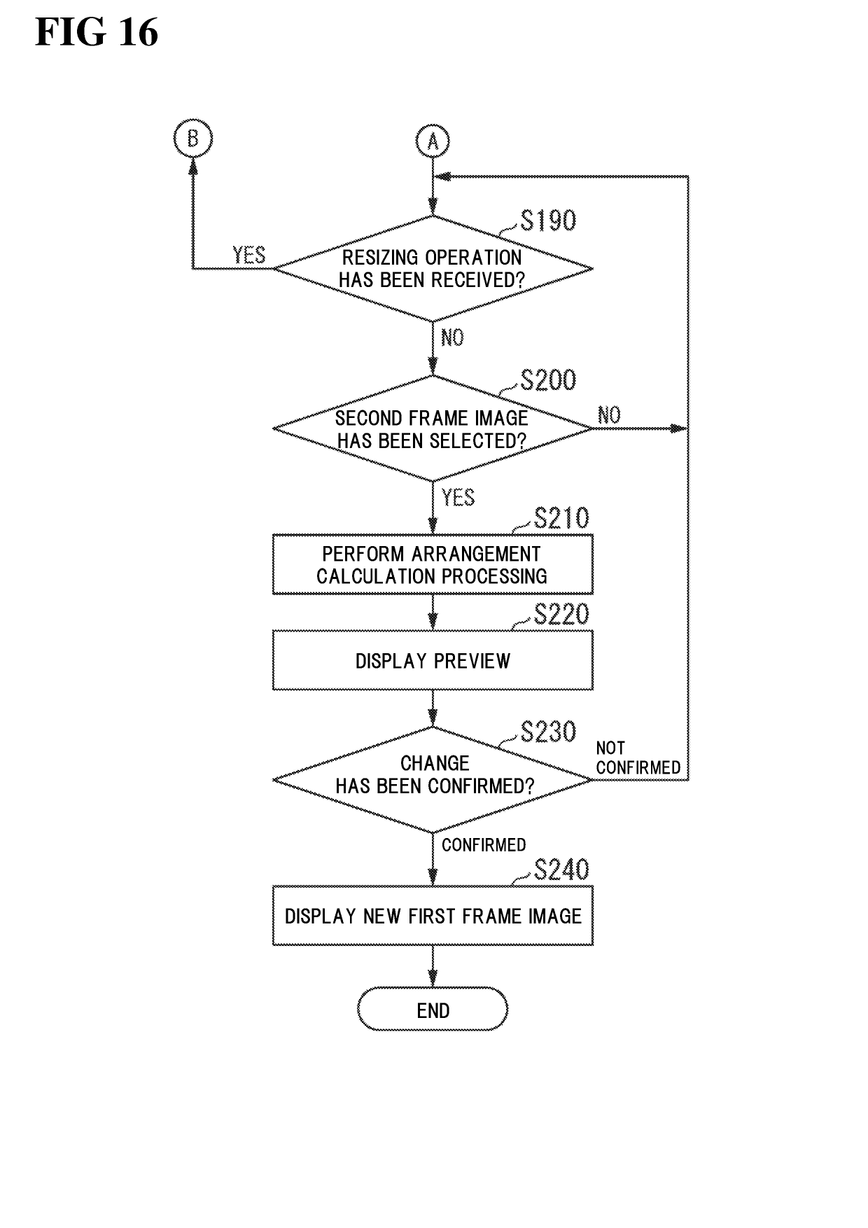

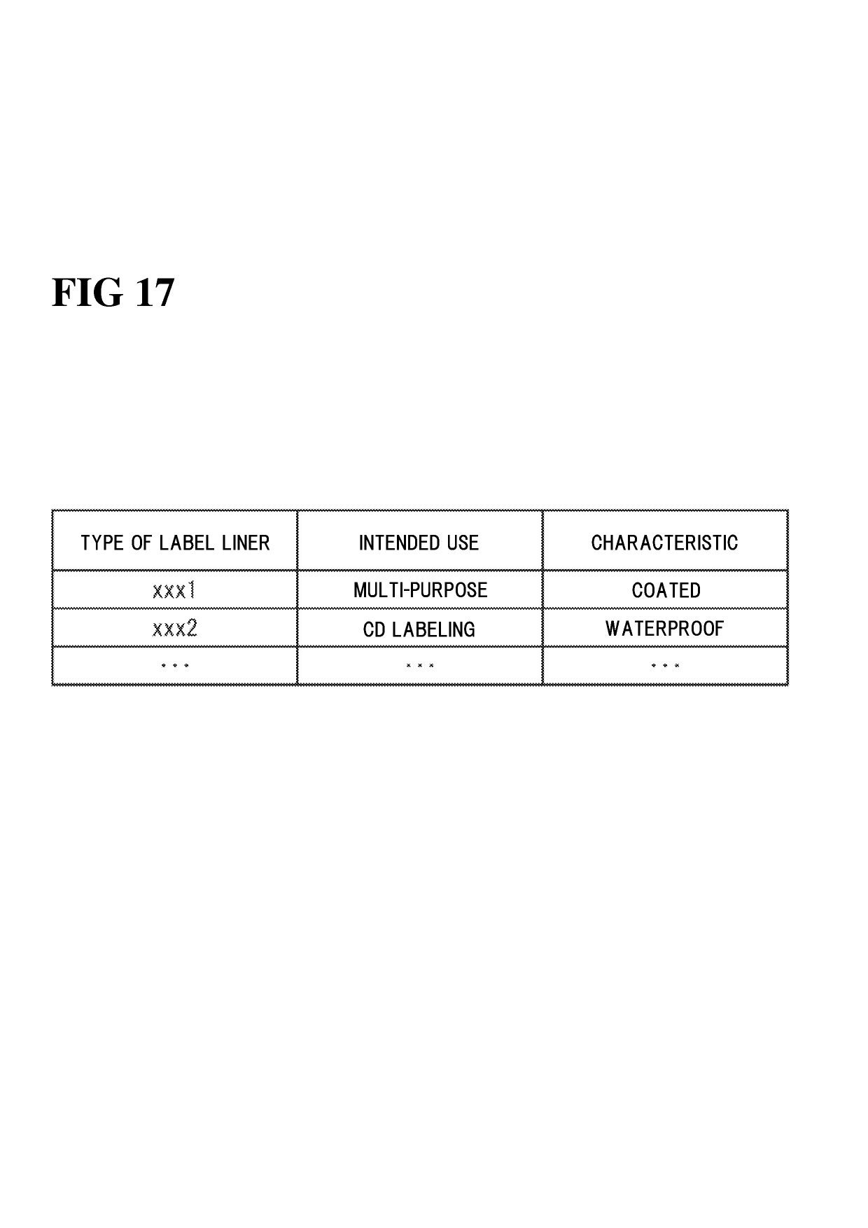

Now, processing in which the terminal device 11 displays a second frame image in accordance with a resizing operation is described with reference to FIG. 15 and FIG. 16. FIG. 15 and FIG. 16 are flowcharts for illustrating one example of a processing flow in which the terminal device 11 displays the second frame image in accordance with the resizing operation. In the following, as an example, a case in which the terminal device 11 has received the resizing operation at a timing before the processing step of Step S110 illustrated in FIG. 15 is performed is described. Further, in the following, as an example, a case in which, at the above-mentioned timing, the terminal device 11 has received in advance an operation for setting whether or not to display a plurality of second frame images is described. A method by which the terminal device 11 receives this operation may be a known method, or may be a method to be developed in the future. Further, in the following, as an example, a case in which the terminal device 11 has received in advance an operation for designating at least one of the intended use or the characteristic of the label liner desired by the user is described. When this operation is received, the terminal device 11 stores information indicating the at least one of the intended use or the characteristic of the label liner desired by the user in the storage unit 112 as the sheet type information. Therefore, in the following, as an example, a case in which the sheet type information has been stored in the storage unit 112 at the above-mentioned timing is described. Further, in the following, as an example, a case in which the above-mentioned printing region information includes, as the sheet type information, the information indicating, for each type of label liner, the at least one of the intended use or the characteristic of the label liner corresponding to the type of label liner is described. FIG. 17 is a table for showing one example of the sheet type information. As shown in FIG. 17, the sheet type information is information in which, for each type of label liner, the type of label liner, the intended use of the label liner, and the characteristic of the label liner are associated with one another. In FIG. 17, for example, the intended use of the label liner of the type "xxx1" is "MULTI-PURPOSE." Further, for example, the characteristic of the label liner of the type "xxx1" is "COATED." Further, in the following, as an example, a case in which one or more objects have been arranged on the first frame image at the above-mentioned timing is described. Further, in the following, as an example, a case in which, at the above-mentioned timing, the terminal device 11 has received in advance an operation for setting whether or not to display only a part of the second frame image is described. A method by which the terminal device 11 receives this operation may be a known method, or may be a method to be developed in the future.

After the resizing operation has been received, the display control module 212 acquires printing device selection status information (Step S110). In this case, the printing device selection status information is information indicating whether or not the model of the printing device has been selected as the user-designated model by the user. A method of acquiring the printing device selection status information may be a known method, or may be a method to be developed in the future. The processing step of Step S110 may be omitted. For example, when the terminal device 11 receives an operation for selecting the model of the printing device as the user-designated model, the terminal device 11 stores, in the storage unit 112, the printing device selection status information indicating that the model of the printing device has been selected as the user-designated model. Meanwhile, for example, when the terminal device 11 has not received the operation for selecting the model of the printing device as the user-designated model, the terminal device 11 stores, in the storage unit 112, the printing device selection status information indicating that the model of the printing device has not been selected as the user-designated model. Therefore, in Step S110, the display control module 212 acquires the printing device selection status information stored in advance in the storage unit 112 from the storage unit 112, for example.

Subsequently, the display control module 212 acquires the sheet type information stored in advance in the storage unit 112 from the storage unit 112 (Step S120). In FIG. 15, the processing step of Step S120 is indicated as "ACQUIRE SHEET TYPE INFORMATION." The processing step of Step S120 may be omitted.

Subsequently, the display control module 212 identifies the label image size corresponding to the received resizing operation as the user-designated label image size (Step S130).

Subsequently, the display control module 212 determines whether or not the terminal device 11 has been set to be able to display a plurality of second frame images (Step S140). In FIG. 15, the processing step of Step S140 is indicated as "PLURALITY OF SECOND FRAME IMAGES CAN BE DISPLAYED?" A method of determining whether or not the terminal device 11 has been set to be able to display a plurality of second frame images may be a known method, or may be a method to be developed in the future.

When the display control module 212 determines that the terminal device 11 has been set to be able to display a plurality of second frame images (YES in Step S140), the display control module 212 identifies a plurality of selectable label image sizes (Step S150). Now, the processing step of Step S150 is described.

In Step S150, the display control module 212 performs processing described below. For example, the display control module 212 causes the printing region information acquisition module 211 to acquire the printing region information, and acquires the printing region information acquired by the printing region information acquisition module 211. After having acquired the printing region information, the display control module 212 causes the sheet type information acquisition module 217 to acquire the sheet type information, and acquires the sheet type information acquired by the sheet type information acquisition module 217. After having acquired the sheet type information, the display control module 212 identifies, as a target label liner candidate, each type of label liner that matches at least one of the intended use or the characteristic indicated by the acquired sheet type information, based on the sheet type information included in the acquired printing region information. After having identified one or more target label liner candidates, the display control module 212 identifies the label image size of the label provided to each of the identified one or more target label liner candidates based on the acquired printing region information. After having identified the label image size of the label provided to each of the one or more target label liner candidates, the display control module 212 identifies a predetermined number of label image sizes in order of closeness to the user-designated label image size from among the identified label image sizes as one or more selectable label image sizes. In the following, as an example, a case in which the predetermined number is 2 is described. In this case, the display control module 212 identifies two label image sizes, namely, the label image size that is closest to the user-designated label image size and the label image size that is second closest to the user-designated label image size, as the selectable label image sizes from among label image sizes of labels provided to the respective identified one or more target label liner candidates. When the processing step of Step S120 is omitted, the display control module 212 identifies two label image sizes, namely, the label image size that is closest to the user-designated label image size and the label image size that is second closest to the user-designated label image size, as the selectable label image sizes from among all label image sizes that can be selected as the selectable label image sizes. The display control module 212 performs such processing as has been described above in Step S150.

After the processing step of Step S150 is performed, the display control module 212 determines whether or not the terminal device 11 has been set to display only a part of the second frame image (Step S160). In FIG. 15, the processing step of Step S160 is indicated as "SET FOR PARTIAL DISPLAY?"

When the display control module 212 determines that the terminal device 11 has been set to display only a part of the second frame image (YES in Step S160), the display control module 212 determines whether or not a user-designated model has been selected based on the printing device selection status information acquired in Step S110 (Step S170). In FIG. 15, the processing step of Step S170 is indicated as "USER-DESIGNATED MODEL HAS BEEN SELECTED?"

When the display control module 212 determines that the user-designated model has been selected (YES in Step S170), the display control module 212 displays only a part of the second frame image having the selectable label image size corresponding to the user-designated model among the identified one or more selectable label image sizes on the data edit image P1 together with the first frame image (Step S180). At this time, the display control module 212 causes the display mode of the first frame image and the display modes of the parts of the respective second frame images having the selectable label image sizes corresponding to the user-designated model to all differ from one another. In FIG. 15, the processing step of Step S180 is indicated as "DISPLAY ONLY PART OF SECOND FRAME IMAGE."

Subsequently, the display control module 212 determines whether or not the resizing operation has been received again (Step S190). In FIG. 16, the processing step of Step S190 is indicated as "RESIZING OPERATION HAS BEEN RECEIVED?"

When the display control module 212 determines that the resizing operation has been received again (YES in Step S190), the display control module 212 advances the process to Step S130 to again identify the label image size corresponding to the received resizing operation as the user-designated label image size.

Meanwhile, when the display control module 212 determines that the resizing operation has not been received again (NO in Step S190), the display control module 212 determines whether or not an operation for selecting any one of the one or more second frame images displayed on the data edit image P1 has been received (Step S200). In FIG. 16, the processing step of Step S200 is indicated as "SECOND FRAME IMAGE HAS BEEN SELECTED?"

When the display control module 212 determines that the operation for selecting any one of the one or more second frame images displayed on the data edit image P1 has not been received (NO in Step S200), the display control module 212 advances the process to Step S190 to again determine whether or not the resizing operation has been received again.

Meanwhile, when the display control module 212 determines that the operation for selecting any one of the one or more second frame images displayed on the data edit image P1 has been received (YES in Step S200), the display control module 212 performs arrangement calculation processing (Step S210). Now, the arrangement calculation processing is described. The arrangement calculation processing includes processing for enlarging or reducing the one or more objects arranged on the first frame image in accordance with a ratio between the label image size of the first frame image and the label image size of the second frame image selected by the above-mentioned operation. In addition, in the arrangement calculation processing, a positional relationship between the one or more objects arranged on the first frame image is determined in accordance with the ratio. A method of performing each of the above-mentioned enlargement, reduction, and determination of the positional relationship in the arrangement calculation processing may be a known method, or may be a method to be developed in the future.

Subsequently, the display control module 212 sets the second frame image selected by the operation received in Step S200 as a new first frame image, and displays, on the display unit 115, a preview of the first frame image and the one or more objects obtained when the one or more objects enlarged or reduced by the arrangement calculation processing in Step S210 are arranged on the new first frame image in the positional relationship determined by the arrangement calculation processing (Step S220). In FIG. 16, the processing step of Step S220 is indicated as "DISPLAY PREVIEW."

Subsequently, the display control module 212 determines whether a confirmation operation for confirming the second frame image selected by the operation received in Step S200 as a new first frame image has been received, or whether a non-confirmation operation for not confirming the second frame image selected by the operation received in Step S200 as a new first frame image has been received (Step S230). In FIG. 16, the processing step of Step S230 is indicated as "CHANGE HAS BEEN CONFIRMED?" The confirmation operation may be any operation that enables the second frame image selected by the operation received in Step S200 to be confirmed as a new first frame image. The non-confirmation operation may be any operation that enables the second frame image selected by the operation received in Step S200 not to be confirmed as a new first frame image.

When the display control module 212 determines that the non-confirmation operation has been received (NOT CONFIRMED in Step S230), the display control module 212 advances the process to Step S190 to again determine whether or not the resizing operation has been received again.

Meanwhile, when the display control module 212 determines that the confirmation operation has been received (CONFIRMED in Step S230), the display control module 212 displays the second frame image selected by the operation received in Step S200 on the data edit image P1 as a new first frame image, and arranges the one or more objects enlarged or reduced by the arrangement calculation processing in Step S210 on the new first frame image in the positional relationship determined by the arrangement calculation processing (Step S240). At this time, when a second frame image other than the second frame image selected by the operation received in Step S200 remains displayed on the data edit image P1, the display control module 212 deletes the second frame image other than the second frame image selected by the operation received in Step S200 from the data edit image P1. In FIG. 16, the processing step of Step S240 is indicated as "DISPLAY NEW FIRST FRAME IMAGE." After having performed the processing step of Step S240, the display control module 212 ends the processing of the flowcharts illustrated in FIG. 15 and FIG. 16.

Meanwhile, when the display control module 212 determines in Step S170 that the user-designated model has not been selected (NO in Step S170), for example, the display control module 212 identifies two selectable label image sizes, namely, the selectable label image size that is closest to the user-designated label image size and the selectable label image size that is second closest to the user-designated label image size, from among the identified one or more selectable label image sizes, and displays only a part of the second frame image having each of the identified two selectable label image sizes together with the first frame image on the data edit image P1 (Step S250). At this time, the display control module 212 causes the display mode of the first frame image and the display modes of the parts of the respective second frame images to all differ from one another. Further, at this time, the display control module 212 displays, for each of the second frame images, information indicating the model of the printing device corresponding to the second frame image in association with the second frame image. The display control module 212 may be configured to, in Step S250, identify the model of the printing device 12 by the determination of the determination module 218, and identify the label image size of the label provided to each of the one or more types of label liners supported by the identified model from among the identified one or more selectable label image sizes. In this case, in Step S250, the display control module 212 identifies two label image sizes, namely, the label image size that is closest to the user-designated label image size and the label image size that is second closest to the user-designated label image size, from among the label image sizes of the labels provided to the respective one or more types of label liners supported by the identified model, and displays only a part of the second frame image having each of the identified two label image sizes together with the first frame image on the data edit image P1. In FIG. 15, the processing step of Step S250 is indicated as "DISPLAY ONLY PART OF SECOND FRAME IMAGE CORRESPONDING TO EACH PRINTING DEVICE." After having performed the processing step of Step S250, the display control module 212 advances the process to Step S190 to again determine whether or not the resizing operation has been received again.

Meanwhile, when the display control module 212 determines in Step S160 that the terminal device 11 has not been set to display only a part of the second frame image (NO in Step S160), the display control module 212 determines whether or not the user-designated model has been selected based on the printing device selection status information acquired in Step S110 (Step S260). In FIG. 15, the processing step of Step S260 is indicated as "USER-DESIGNATED MODEL HAS BEEN SELECTED?"

When the display control module 212 determines that the user-designated model has been selected (YES in Step S260), the display control module 212 displays the second frame image having the selectable label image size corresponding to the user-designated model among the identified one or more selectable label image sizes on the data edit image P1 together with the first frame image (Step S270). In FIG. 15, the processing step of Step S270 is indicated as "DISPLAY SECOND FRAME IMAGE." After having performed the processing step of Step S270, the display control module 212 advances the process to Step S190 to again determine whether or not the resizing operation has been received again.

Meanwhile, when the display control module 212 determines in Step S260 that the user-designated model has not been selected (NO in Step S260), for example, the display control module 212 identifies two selectable label image sizes, namely, the selectable label image size that is closest to the user-designated label image size and the selectable label image size that is second closest to the user-designated label image size, from among the identified one or more selectable label image sizes, and displays the second frame image having each of the identified two selectable label image sizes together with the first frame image on the data edit image P1 (Step S280). At this time, the display control module 212 causes the display mode of the first frame image and the display modes of the parts of the respective second frame images to all differ from one another. Further, at this time, the display control module 212 displays, for each of the second frame images, the information indicating the model of the printing device corresponding to the second frame image in association with the second frame image. The display control module 212 may be configured to, in Step S280, identify the model of the printing device 12 by the determination of the determination module 218, and identify the label image size of the label provided to each of the one or more types of label liners supported by the identified model from among the identified one or more selectable label image sizes. In this case, in Step S280, the display control module 212 identifies two label image sizes, namely, the label image size that is closest to the user-designated label image size and the label image size that is second closest to the user-designated label image size, from among the label image sizes of the labels provided to the respective one or more types of label liners supported by the identified model, and displays the second frame image having each of the identified two label image sizes together with the first frame image on the data edit image P1. In FIG. 15, the processing step of Step S280 is indicated as "DISPLAY SECOND FRAME IMAGE CORRESPONDING TO EACH PRINTING DEVICE." After having performed the processing step of Step S280, the display control module 212 advances the process to Step S190 to again determine whether or not the resizing operation has been received again.

Meanwhile, when the display control module 212 determines in Step S140 that the terminal device 11 has not been set to be able to display a plurality of second frame images (NO in Step S140), the display control module 212 identifies one selectable label image size (Step S290). Now, the processing step of Step S290 is described.

In Step S290, the display control module 212 performs processing described below. For example, the display control module 212 causes the printing region information acquisition module 211 to acquire the printing region information, and acquires the printing region information acquired by the printing region information acquisition module 211. After having acquired the printing region information, the display control module 212 causes the sheet type information acquisition module 217 to acquire the sheet type information, and acquires the sheet type information acquired by the sheet type information acquisition module 217. After having acquired the sheet type information, the display control module 212 identifies, as a target label liner candidate, each type of label liner that matches at least one of the intended use or the characteristic indicated by the acquired sheet type information, based on the sheet type information included in the acquired printing region information. After having identified one or more target label liner candidates, the display control module 212 identifies the label image size of the label provided to each of the identified one or more target label liner candidates based on the acquired printing region information. After having identified the label image size of the label provided to each of the one or more target label liner candidates, the display control module 212 identifies the label image size that is closest to the user-designated label image size from among the identified label image sizes as the selectable label image size. When the processing step of Step S120 is omitted, the display control module 212 identifies the label image size that is closest to the user-designated label image size as the selectable label image size from among all label image sizes that can be selected as the selectable label image sizes. The display control module 212 performs such processing as has been described above in Step S290.

Through the above-mentioned processing, the terminal device 11 displays the second frame image in accordance with the resizing operation. With this configuration, the terminal device 11 enables a visual comparison between a frame image before a change in size and a frame image after the change in size, and can thereby improve usability regarding the change in size of the frame image.

In the flowcharts illustrated in FIG. 15 and FIG. 16, the processing step of Step S210 may be omitted. In this case, in Step S220 and Step S240, the terminal device 11 displays an object having the same dimensions as those of each of the objects displayed on the first frame image so as to be superimposed on the new first frame image (that is, on the second frame image selected by the user) regardless of the ratio between the label image size of the first frame image and the label image size of the second frame image.

Further, the terminal device 11 may be configured to, when displaying the first frame image and the one or more second frame images in different display modes in Step S250 and Step S280, display the first frame image and the one or more second frame images such that both differ in some or all of the colors, the shapes, the line types, and the like thereof.

Further, the matters described above may be combined in any manner.

### <Supplementary Notes>

[1] A terminal device for editing print data to be output to a printing device, the terminal device including: a printing region information acquisition module configured to acquire printing region information that specifies a printing region provided to a printing sheet for each type of printing sheet; a display control module configured to select a printing sheet of a first type and a printing sheet of each of one or a plurality of second types different from the first type based on the acquired printing region information, and display, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and an operation reception unit configured to receive an operation for changing dimensions of the printing region.

[2] The terminal device according to Item [1], wherein the display control module is configured to display the second frame image in one of an inside or an outside of the first frame image in accordance with a direction of the received operation.

[3] The terminal device according to Item [1] or [2], wherein the display control module is configured to display the second frame image by selecting, as the printing sheet of each of the one or the plurality of second types, the printing sheet having the printing region having dimensions corresponding to an amount of the received operation with the dimensions of the printing region provided to the printing sheet of the first type being used as a reference among a plurality of types of printing sheets specified in the printing region information.

[4] The terminal device according to Item [1], wherein the display control module is configured to display the second frame image by selecting, as the printing sheet of each of the one or the plurality of second types, the printing sheet having the printing region having dimensions that are closest to the dimensions of the printing region provided to the printing sheet of the first type among a plurality of types of printing sheets specified in the printing region information.

[5] The terminal device according to any one of Items [1] to [4], wherein the printing region information includes information indicating a type of printing sheet that is compatible with the printing device for each model of the printing device, wherein the terminal device further includes a model information acquisition module configured to acquire model information indicating the model of the printing device, and wherein the display control module is configured to display the frame images by selecting the printing sheet of the first type and the printing sheet of each of the one or the plurality of second types from among the printing sheets that are compatible with the printing device of the model indicated by the model information among a plurality of types of printing sheets specified in the printing region information.

[6] The terminal device according to any one of Items [1] to [5], wherein the printing region information includes, for each type of printing sheet, information indicating at least one of intended use or a characteristic of the printing sheet corresponding to the each type of printing sheet, wherein the terminal device further includes a sheet type information acquisition module configured to acquire sheet type information indicating the at least one of the intended use or the characteristic of the printing sheet, and wherein the display control module is configured to display the frame images by selecting the printing sheet of the first type and the printing sheet of each of the one or the plurality of second types from among the printing sheets that match the at least one of the intended use or the characteristic indicated by the sheet type information among a plurality of types of printing sheets specified in the printing region information.

[7] The terminal device according to any one of Items [1] to [6], wherein the display control module is configured to display, as the second frame image, an image representing a partial outline included in an outline of the printing region indicated by the printing region information.

[8] The terminal device according to any one of Items [1] to [7], wherein the display control module is configured to display the second frame images in display modes caused to differ between models of printing devices.

[9] The terminal device according to any one of Items [1] to [8], wherein the display control module is configured to display an object representing an image to be printed so as to be superimposed on the first frame image, and display the object subjected to one of enlargement or reduction in accordance with a ratio between the dimensions of the printing region indicated by the first frame image and the dimensions of the printing region indicated by the second frame image so as to be superimposed on the second frame image.

The terminal device according to any one of Items [1] to [8], wherein the display control module is configured to display an object representing an image to be printed so as to be superimposed on the first frame image, and display the object having the same dimensions as dimensions of the object displayed on the first frame image so as to be superimposed on the second frame image regardless of a ratio between the dimensions of the printing region indicated by the first frame image and the dimensions of the printing region indicated by the second frame image.

The terminal device according to any one of Items [1] to [10], wherein the display control module is configured to display each of the frame images having an original size, in which the dimensions of the printing region and dimensions of the each of the frame images on the display unit match each other.

A printing system, including: the terminal device of any one of Items [1] to [11] ; and a printing device to be connected, which is a printing device that is electrically connected to the terminal device in one of a wireless manner or a wired manner, wherein the terminal device includes a determination module configured to acquire model information indicating a model of the printing device to be connected from the printing device to be connected, to thereby determine the model of the printing device to be connected.

A method of editing print data to be output to a printing device, the method including: acquiring printing region information that specifies a printing region provided to a printing sheet for each type of printing sheet; selecting a printing sheet of a first type and a printing sheet of each of one or a plurality of second types different from the first type based on the acquired printing region information, and displaying, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and receiving an operation for changing dimensions of the printing region.

A program for causing a computer included in a terminal device for editing print data to be output to a printing device to execute: acquiring printing region information that specifies a printing region provided to a printing sheet for each type of printing sheet; selecting a printing sheet of a first type and a printing sheet of each of one or a plurality of second types different from the first type based on the acquired printing region information, and displaying, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and receiving an operation for changing dimensions of the printing region.

The at least one embodiment of the present disclosure has been described above in detail with reference to the drawings, but specific configurations are not limited to those of the at least one embodiment, and some of the configurations may be changed, substituted, or deleted, for example, within a range that does not deviate from the gist of the present disclosure.

Further, a program for implementing the function of any component of the device described above (for example, the terminal device 11 or the printing device 12) may be recorded in a computer-readable recording medium so that the program is read by a computer system to be executed. The "computer system" as used herein includes an operating system (OS) or hardware including peripheral devices. Further, the "computer-readable recording medium" is a portable medium such as a flexible disk, a magneto-optical disk, a read only memory (ROM), or a compact disc ROM (CD-ROM), or a storage device built in the computer system, such as a hard disk drive. The term "computer-readable recording medium" also includes a medium which holds a program for a fixed period of time, for example, a volatile memory (random access memory (RAM)) included in a computer system serving as a server or a client in a case in which a program is transmitted via a network such as the Internet, or a communication line such as a telephone line.

The above-mentioned program may be transmitted from the computer system in which the program is stored in, for example, the storage device, to another computer system via a transmission medium or through a transmission wave in a transmission medium. The "transmission medium" as used herein through which a program is transmitted refers to a medium having a function of transmitting information, for example, a network (communication network) such as the Internet or a communication line (communication wire) such as a telephone line.

Further, the above-mentioned program may be intended to implement some of the functions described above. Further, the above-mentioned program may be a program that enables the functions described above to be implemented when being combined with a program that is already recorded in the computer system, which is what is called "differential file" (differential program).

What is claimed is:

1. A terminal device for editing print data to be output to a printing device, the terminal device comprising:
a printing region information acquisition module configured to acquire printing region information that specifies a printing region provided to a printing sheet for each type of printing sheet;
a display control module configured to select a printing sheet of a first type and a printing sheet of each of one or a plurality of second types different from the first type based on the acquired printing region information, and display, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and
an operation reception unit configured to receive an operation for changing dimensions of the printing region.

2. The terminal device according to claim 1, wherein the display control module is configured to display the second frame image in one of an inside or an outside of the first frame image in accordance with a direction of the received operation.

3. The terminal device according to claim 1, wherein the display control module is configured to display the second frame image by selecting, as the printing sheet of each of the one or the plurality of second types, the printing sheet having the printing region having dimensions corresponding to an amount of the received operation with the dimensions of the printing region provided to the printing sheet of the first type being used as a reference among a plurality of types of printing sheets specified in the printing region information.

4. The terminal device according to claim 1, wherein the display control module is configured to display the second frame image by selecting, as the printing sheet of each of the one or the plurality of second types, the printing sheet having the printing region having dimensions that are closest to the dimensions of the printing region provided to the printing sheet of the first type among a plurality of types of printing sheets specified in the printing region information.

5. The terminal device according to claim 1,
wherein the printing region information includes information indicating a type of printing sheet that is compatible with the printing device for each model of the printing device,
wherein the terminal device further comprises a model information acquisition module configured to acquire model information indicating the model of the printing device, and
wherein the display control module is configured to display the frame images by selecting the printing sheet of the first type and the printing sheet of each of the one or the plurality of second types from among the printing sheets that are compatible with the printing device of the model indicated by the model information among a plurality of types of printing sheets specified in the printing region information.

6. The terminal device according to claim 1,
wherein the printing region information includes, for each type of printing sheet, information indicating at least one of intended use or a characteristic of the printing sheet corresponding to the each type of printing sheet,
wherein the terminal device further comprises a sheet type information acquisition module configured to acquire sheet type information indicating the at least one of the intended use or the characteristic of the printing sheet, and
wherein the display control module is configured to display the frame images by selecting the printing sheet of the first type and the printing sheet of each of the one or the plurality of second types from among the printing sheets that match the at least one of the intended use or the characteristic indicated by the sheet type information among a plurality of types of printing sheets specified in the printing region information.

7. The terminal device according to claim 1, wherein the display control module is configured to display, as the second frame image, an image representing a partial outline included in an outline of the printing region indicated by the printing region information.

8. The terminal device according to claim 1, wherein the display control module is configured to display the second frame images in display modes caused to differ between models of printing devices.

9. The terminal device according to claim 1, wherein the display control module is configured to display an object representing an image to be printed so as to be superimposed on the first frame image, and display the object subjected to one of enlargement or reduction in accordance with a ratio between the dimensions of the printing region indicated by the first frame image and the dimensions of the printing region indicated by the second frame image so as to be superimposed on the second frame image.

10. The terminal device according to claim 1, wherein the display control module is configured to display an object representing an image to be printed so as to be superimposed on the first frame image, and display the object having the same dimensions as dimensions of the object displayed on the first frame image so as to be superimposed on the second frame image regardless of a ratio between the dimensions of the printing region indicated by the first frame image and the dimensions of the printing region indicated by the second frame image.

11. The terminal device according to claim 1, wherein the display control module is configured to display each of the frame images having an original size, in which the dimensions of the printing region and dimensions of the each of the frame images on the display unit match each other.

12. A printing system, comprising:
the terminal device according to claim 1; and
a printing device to be connected, which is a printing device that is electrically connected to the terminal device in one of a wireless manner or a wired manner,
wherein the terminal device includes a determination module configured to acquire model information indicating a model of the printing device to be connected from the printing device to be connected, to thereby determine the model of the printing device to be connected.

13. A method of editing print data to be output to a printing device, the method comprising:
acquiring printing region information that specifies a printing region provided to a printing sheet for each type of printing sheet;
selecting a printing sheet of a first type and a printing sheet of each of one or a plurality of second types different from the first type based on the acquired printing region information, and displaying, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and
receiving an operation for changing dimensions of the printing region.

14. A program for causing a computer included in a terminal device for editing print data to be output to a printing device to execute:
acquiring printing region information that specifies a printing region provided to a printing sheet for each type of printing sheet;
selecting a printing sheet of a first type and a printing sheet of each of one or a plurality of second types different from the first type based on the acquired printing region information, and displaying, among frame images indicating printing regions, a first frame image indicating the printing region provided to the selected printing sheet of the first type and a second frame image indicating the printing region provided to the selected printing sheet of each of the one or the plurality of second types on a display unit such that the first frame image and the second frame image appear in different display modes; and
receiving an operation for changing dimensions of the printing region.
